(19) United States
(12) Patent Application Publication
(10) Pub. No.: US 2006/0098421 A1
(43) Pub. Date: May 11, 2006

(54) Air blower unit for inflatable body

(76) Inventors: Barry Fireman, Sharon, MA (US); Allan R. Ferraro SR., Attleboro, MA (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 11/305,999

(22) Filed: Dec. 19, 2005

Related U.S. Application Data
(63) Continuation-in-part of application No. 11/032,678, filed on Jan. 10, 2005.
(60) Provisional application No. 60/621,826, filed on Oct. 25, 2004.
(60) Provisional application No. 60/535,960, filed on Jan. 12, 2004.

(51) Int. Cl. F21V 33/00

(52) U.S. Cl. 362/96

(57) ABSTRACT

The present invention is directed to an air blower unit for inflating an air permeable body. The air permeable body has an inlet sleeve with a distal end and a light unit located within the body. The air blower unit comprises an exhaust port engageable with the distal end of the inlet sleeve for delivering air to the body thru the inlet sleeve. The air blower unit further comprises an electrical cord passing into and out of the exhaust port and thru the inlet sleeve of the body for connection with a light unit. The air blower unit may further comprise a protective cover to enclose the electrical cord as it passes into and within the exhaust port.

### CROSS-REFERENCE TO RELATED APPLICATIONS

This application is a continuation-in-part of and claims priority to U.S. application Ser. No. 11/032,678 filed on Jan. 10, 2005, now pending, which is hereby incorporated in its entirety by reference into this application. Application Ser. No. 11/032,678 claims priority to U.S. provisional application Ser. No. 60/535,960 filed on Jan. 12, 2004, now abandoned, which is hereby incorporated by reference in its entirety into this application, and to U.S. provisional application Ser. No. 60/621,826 filed on Oct. 25, 2004, now abandoned, which is hereby incorporated by reference in its entirety into this application

### BACKGROUND OF THE INVENTION

A variety of commercial air blower units have been developed for inflating a sign or character. Such conventional devices typically have exposed electrical wiring that makes the devices hazardous for use by consumers of mass market goods. In this regard, mass market retailers typically do not accept goods that are not certified by Underwriters Laboratories (UL). In recent years, mass market air blower units for use in inflating air permeable decorative characters, such as a snowman or a witch, have become quite popular. One type of conventional air blower unit is described in U.S. Pat. No. 6,644,843, which discloses an air permeable body having the blower of the air blower unit and a light source disposed within the body to inflate and illuminate the body. Such conventional constructions have several drawbacks. By way of example only, they do not allow the character to stand erect in a stable manner even with the use of external ropes. By way of further example, they are difficult to assemble in compliance with UL standards in a cost effective manner. By way of further example, the air blower unit in such conventional constructions require manipulation of multiple legs for both the operation and storage, thereby making the construction cumbersome to deploy, use and store for the consumer.

### SUMMARY OF THE INVENTION

The present invention is an air blower unit for inflating an air permeable body such as a decorative character. The air permeable body has an inlet sleeve extending therefrom and one or more light units located within the body. In one embodiment, the air blower unit comprises an exhaust port engageable with the distal end of the inlet sleeve for delivering air to the body through the inlet sleeve. The air blower unit further comprises an electrical cord passing through the inlet sleeve of the body and electrically engageable with the light unit. Preferably, the electrical cord passes into and out of the exhaust port and then through the inlet sleeve of the body. The air blower unit may further comprise a protective cover to enclose the electrical cord as it passes into the exhaust port. Unlike in conventional mass market constructions, passing the electrical cord thru the inlet sleeve provides a safe and cost effective way to enable illumination of an air permeable body.

### BRIEF DESCRIPTION OF THE DRAWINGS

The following description of the invention will be more fully understood with reference to the accompanying drawings in which:

FIGS. 1 is a perspective view of the air blower unit according to the present invention engaged with an air permeable body such as a decorative character;

FIGS. 2 and 3 are perspective views of the air blower unit according to the present invention;

FIG. 4 is a rear view of the air blower unit

FIG. 5 is a right side view of the air blower unit showing the air inlet sleeve of the body engaged about the exhaust port, a light harness having an electrical cord extending through an inlet sleeve and into the exhaust port, and a light unit electrically connected to the light harness and disposed within the body;

FIG. 6 is an exploded view of the air blower unit;

FIG. 7 is a perspective view of the impeller housing;

FIG. 8 is a front view of the impeller housing;

FIG. 9 is a top view of the impeller housing;

FIG. 10 is a right side view of the impeller housing;

FIG. 11 is a perspective view of the motor housing;

FIG. 12 is a front view of the motor housing;

FIG. 13 is a left side view of the motor housing;

FIG. 14 is a right side view of the motor housing;

FIG. 15 is a bottom view of the motor housing;

FIG. 16 is a partial exploded view of the air blower unit with the motor cover removed showing a portion of the electrical cord passing from the motor into the exhaust port and the protective cover;

FIG. 17 is an enlarged view of Detail 17 of FIG. 16;

FIG. 18 is an exploded perspective view of the motor cover and the front and rear vent members;

FIG. 19 is a perspective view of the motor cover;

FIG. 20 is a front view of the motor cover;

FIG. 21 is an enlarged view of Detail 21 of FIG. 20;

FIG. 22 is a side view of the motor cover;

FIG. 23 is a rear view of the motor cover;

FIGS. 24 and 25 are perspective views of the front vent member;

FIG. 26 is a front view of the front vent member;

FIG. 27 is a side view of the front vent member;

FIGS. 28 and 29 are perspective views of the rear vent member;

FIG. 30 is a front view of the rear vent member;

FIG. 31 is a side view of the rear vent member;

FIG. 32 is a top view of the air blower unit with the motor cover removed and the front and rear vent members engaged with the motor housing;

FIG. 33 is a cross-section view taken along line 33-33 of FIG. 32;

FIG. 34 is an enlarged view of Detail 33 of FIG. 33;

FIG. 35 is a partial exploded view of the air blower unit with the impeller housing removed and showing the internal vent holes aligned in a radial pattern about the perimeter of the impeller;

FIG. 36 is an enlarged view of Detail 36 of FIG. 35.

FIG. 37 is a right side view of the motor housing;

FIG. 38 is a cross-section view taken along line 38-38 of FIG. 37;

FIG. 39 is an enlarged view of Detail 39 of FIG. 38;

FIG. 40 is a cross-section view taken along line 40-40 of FIG. 37; and

FIG. 41 is an enlarged view of Detail 41 of FIG. 40.

### DETAILED DESCRIPTION OF THE INVENTION

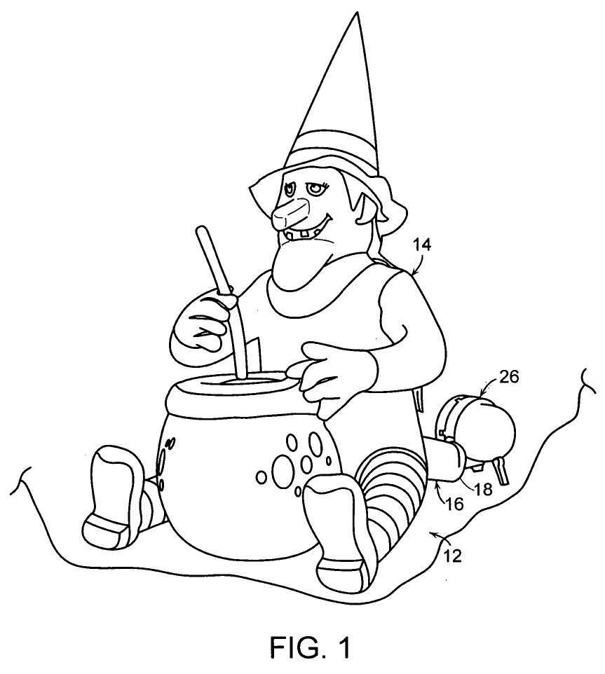

Referring to FIGS. 1-6, the present invention is an air blower unit 26 for inflating and illuminating an air permeable body 14 such as a decorative character in the shape of a seated witch. The air permeable body 14 has an inlet sleeve 16 extending therefrom and terminating at a distal end 18, a bottom portion 24 (FIG. 5) resting on the ground 12, and a light unit 38 located in the body 14. The air blower unit 26 comprises an exhaust port 28 engageable with the distal end 18 of the inlet sleeve 16 for delivering air to the body 14 thru the inlet sleeve 16. The air blower unit 26 further comprises an electrical cord 32 passing thru the inlet sleeve 16 of the body 14 and electrically engageable with the light unit 38. Preferably, the electrical cord 32 passes into and out of the exhaust port 28 and then thru the inlet sleeve 16 of the body 14.

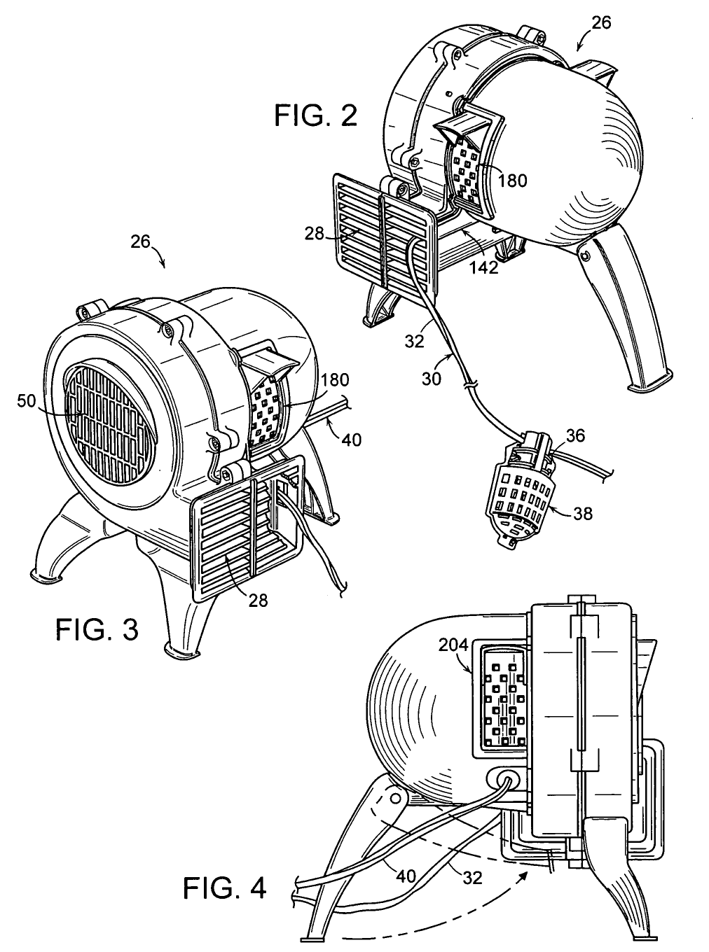

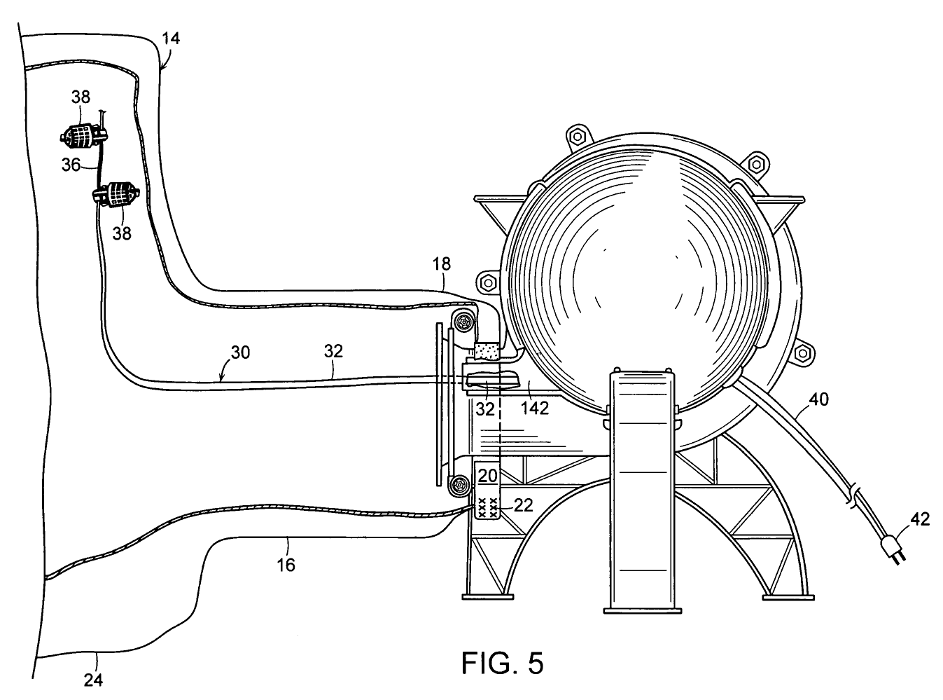

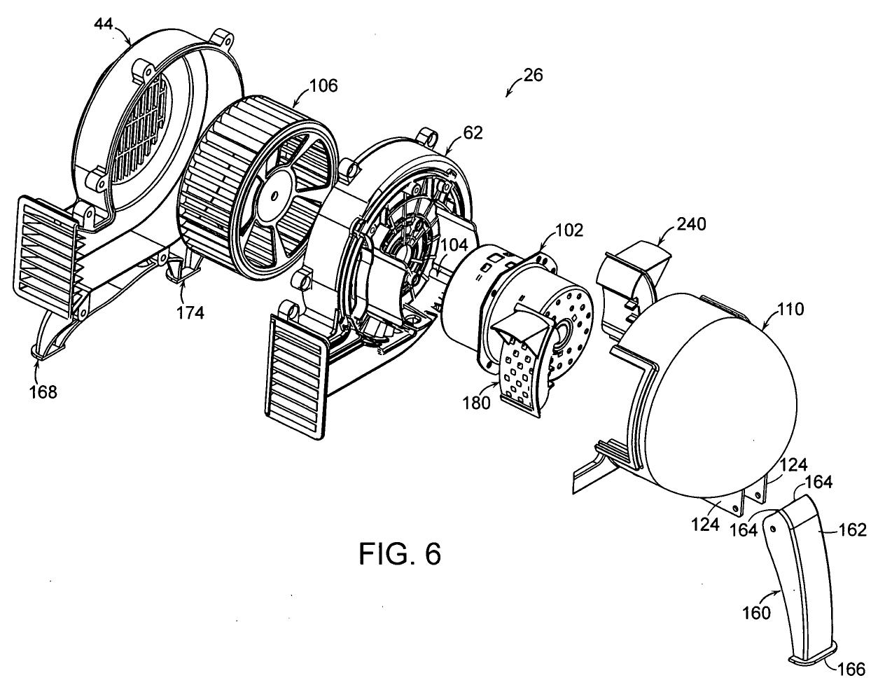

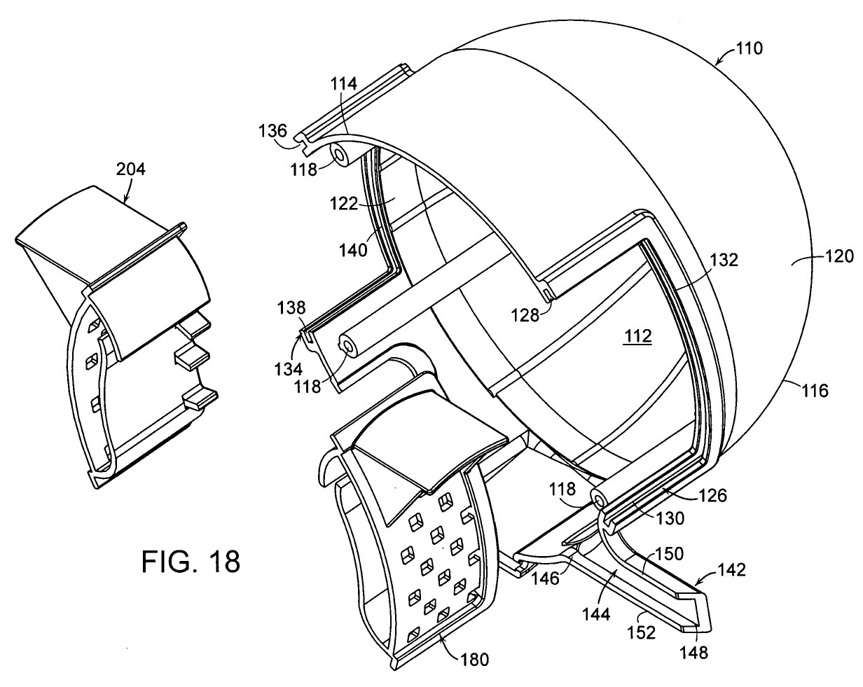

The air blower unit 26 may further comprise a protective cover 142 (FIG. 2) adapted to enclose the electrical cord 32 as it passes into the exhaust port 28. As will be described more fully herein, the protective cover 142 is formed as part of the motor cover 110 (FIG. 6) and may comprise an outer end portion 148 (FIG. 18) extending into the exhaust port 28. The inlet sleeve 16 of the body 14 is preferably positioned over the exhaust port 28 such that it covers a portion of the protective cover 142, and it is tied to the exhaust port 28 by a strap 20 having a fastener 22 such as a hook-and-loop fastener.

The air blower unit 26 further comprises a motor housing 62 (FIG. 6) engaged with the impeller housing 44 and an air inlet port 50 (FIG. 3) formed as part of the impeller housing 44. The air blower unit 26 further comprises a motor 102 having a shaft portion 104 and a cage or impeller 106 adapted to engage with the end of the shaft portion 104. The air blower unit 26 further comprises a motor cover 110 adapted to engage with the motor housing 62 to enclose the motor 102. The air blower unit 26 further comprises a power cord 40 (FIG. 5) having a plug 42 adapted to connect to an external power source (not shown). The power cord 40 is electrically connected to the motor 102 and the electrical cord 32 by conventional means so that upon connection of plug 42 to an external power source, both the motor 102 and light unit 38 are or may be turned on. As will be described more fully herein, the air blower unit 26 further comprises first and second vent members 180 and 204 adapted to provide ventilation for the motor 102.

The air blower unit 26 further comprises first, second, and third leg members 160, 168, and 174, respectively. (FIG. 6) The first leg member 160 is rotatably engaged to the motor cover 110 between a deployed position where the first leg member 160 is fully extended and a stored position where the first leg member 160 is disposed under the motor cover 110. The first leg member 160 has an upper end portion 162 having a flange portion 164 and a lower end portion 166 adapted to rest on the ground. The first leg member 160 is rotatably engaged about flange portions 124 of the motor cover 110 by a pin (not shown) or other conventional fastener. The second and third leg members 168 and 174 are formed as part of the impeller housing 44 and are fixed in position. The first, second, and third leg members 160, 168, and 174 form a substantially triangular pattern when the first leg is in the deployed position.

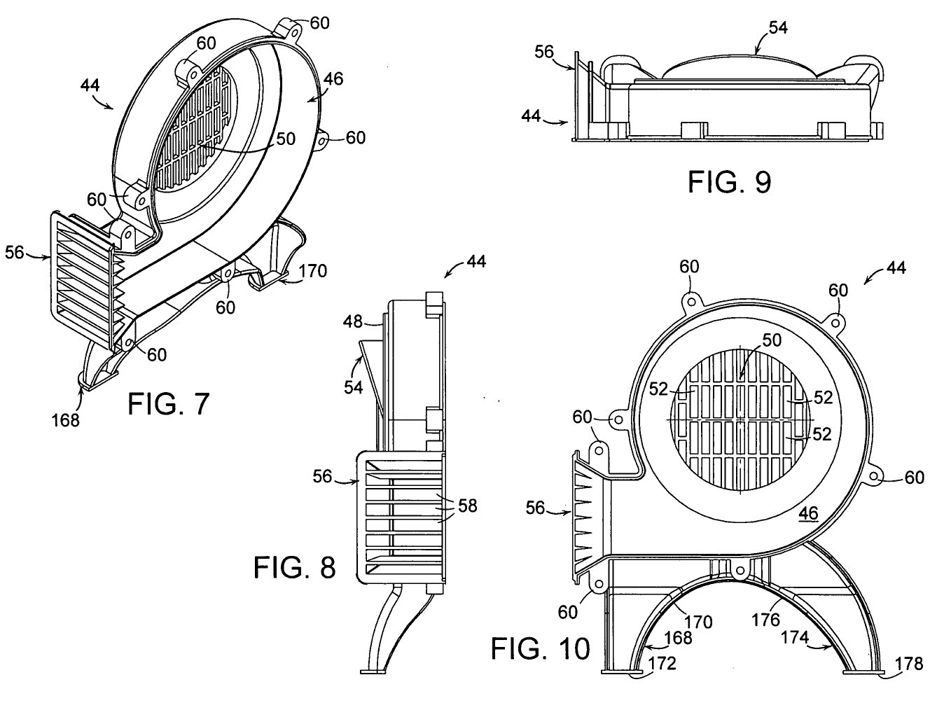

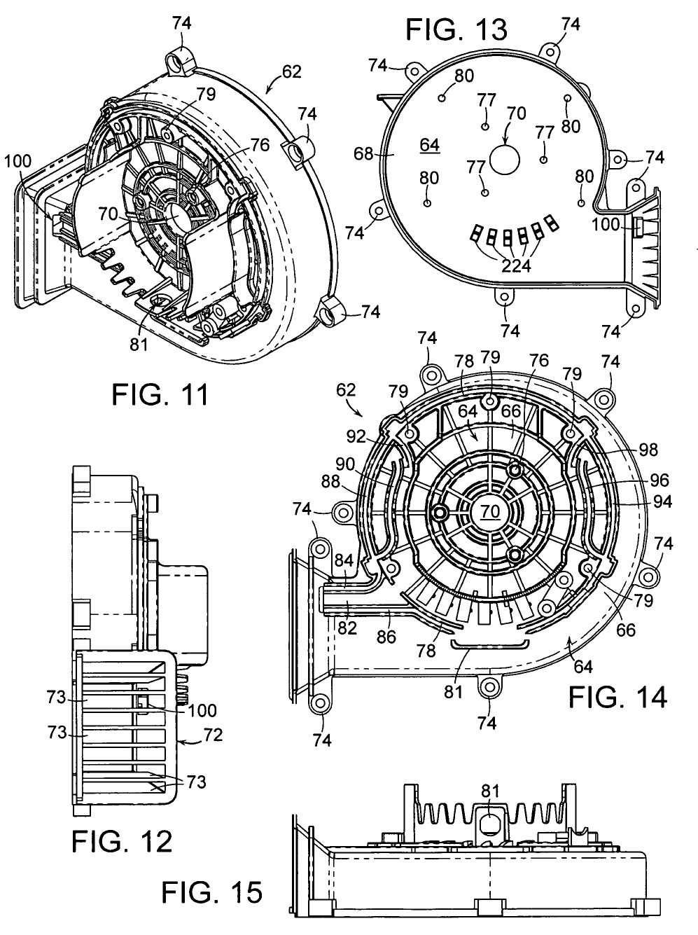

Referring to FIGS. 7-10, the impeller housing 44 comprises an open cavity portion 46, a side portion 48 (FIG. 8), and the air inlet port 50 having a plurality of openings 52 (FIG. 10). The impeller housing 44 may comprise a water shield 54 (FIG. 9) disposed above the air inlet port 50 to reduce the possibility of water entering the air inlet port 50 during outdoor use, and specifically in rain or snow. The impeller housing 44 further comprises a first exhaust portion 56 having a plurality of grill or channel shaped openings 58. The first exhaust portion 56 engages with a second exhaust portion 72 of the motor housing 62 (see FIG. 12) to form the exhaust port 28. The impeller housing 44 further comprises a plurality of mounting bosses 60 adapted to engage with mounting bosses 74 (to be described) of the motor housing 62 (FIG. 11) by conventional fasteners such as screws.

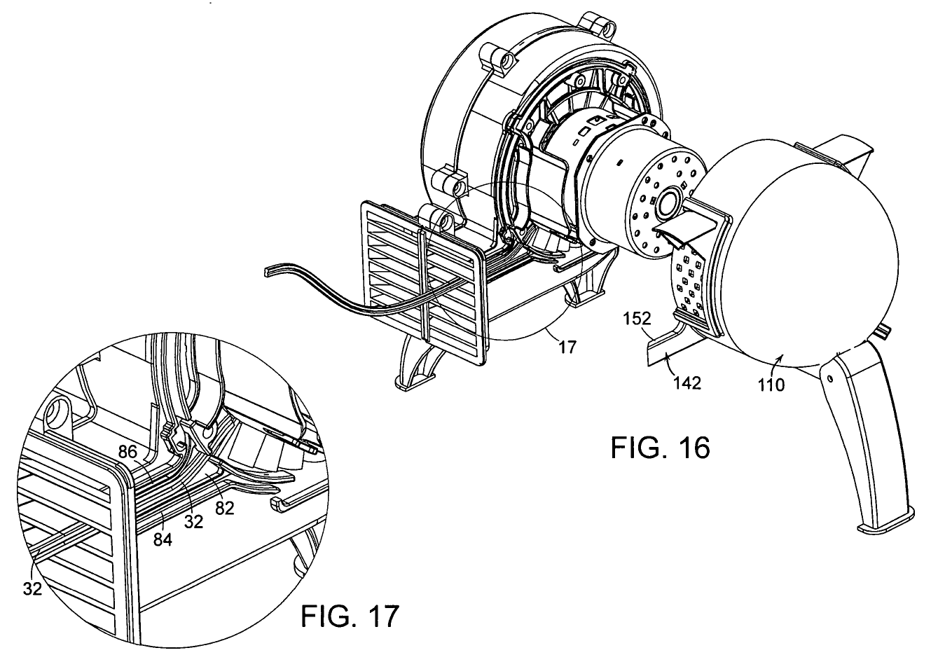

Referring to FIGS. 11-15, the motor housing 62 generally comprises a central wall or floor portion 64 (FIG. 14) having an outer surface 66 and an inner surface 68. The motor housing 62 further comprises a central opening 70 adapted to allow the shaft portion 104 of the motor 102 (FIG. 6) to pass thru the floor portion 64 for engagement with the impeller 106. The motor housing 62 further comprises a second exhaust portion 72 (FIG. 12) having a plurality of channel shaped openings 73. The second exhaust portion 72 is adapted to engage with the first exhaust portion 56 (FIG. 7) of the impeller housing 44 to form the exhaust port 28. As indicated, the motor housing 62 is secured to the impeller housing 44, forming an impeller cavity 154. A plurality of mounting bosses 76 having holes 77 (FIG. 13) are adapted to securely mount the motor 102 to the floor portion 64 of the motor housing 62 by conventional means such as screws. The motor housing 62 further includes a plurality of mounting bosses 79 having holes 80 adapted to securely engage the motor cover 110 (FIG. 18) by conventional means such as screws, to form a motor cavity 156. An annular channel portion 78 is disposed substantially about the perimeter of the floor portion 64. The channel portion 78 is adapted to engage with the lower end portion 114 of the motor cover 110 (FIG. 18). A strain relief opening 81 is adapted to receive a plug (not shown) with the electrical cord 32 passing to the motor 102. An elongated open channel portion 82 has abutting side wall channels 84 and 86, and an opening 100 (FIG. 12) disposed in a sidewall of the second exhaust portion 72. As shown in FIGS. 16 and 17, the electrical cord 32 is disposed within the open channel portion 82, and the sidewall channel portions 84 and 86 are adapted to engage with the sidewalls 150 and 152 of the protective cover 142 (FIG. 18), respectively, to enclose and protect the electrical cord 32 as it passes from the motor cover 110 into the exhaust port 28 via opening 100. The motor housing 62 further comprises a first exterior channel portion 88, a first interior channel portion 90, and a second interior channel portion 92 (FIG. 14). As will be described more fully herein, the first exterior channel portion 88, first interior channel portion 90, and second interior channel portion 92 are adapted to engage with the first vent member 180 (FIG. 18). A second exterior channel portion 94, a third interior channel portion 96, and a fourth interior channel portion 98 are also provided. As will be described more fully herein, second exterior channel portion 94, third interior channel portion 96, and the fourth interior channel portion 98 are adapted to engage with the second vent member 204 (FIG. 18).

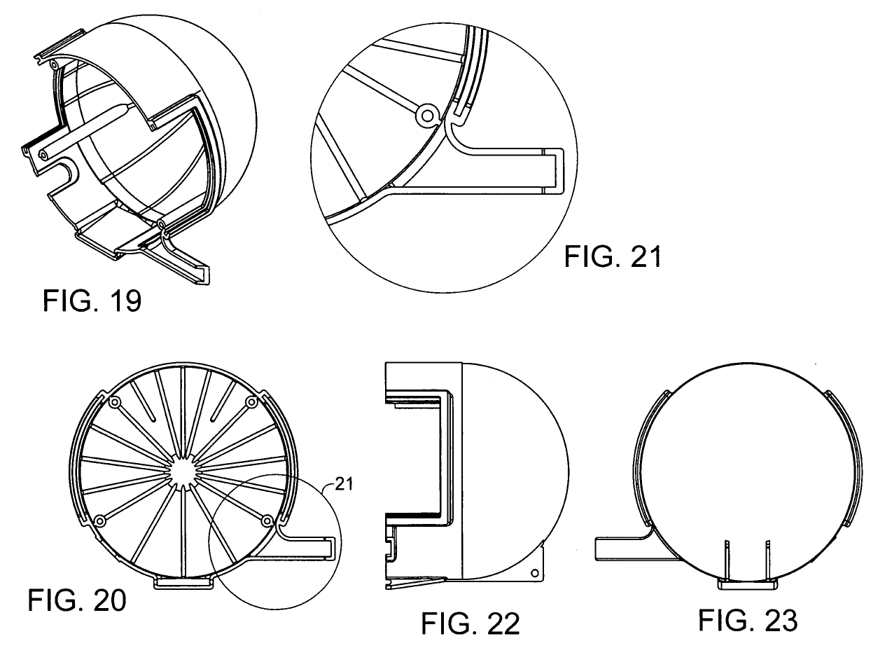

Referring to FIGS. 18-23, the motor cover 110 generally comprises a cavity portion 112, a lower end portion 114, and upper end portion 116, a front side portion 120 and a rear side portion 122. A plurality of mounting bosses 118 are adapted to engage with mounting bosses 79 of the motor housing 62 (FIG. 11) to secure the motor cover 110 to the motor housing 62. As previously described, the motor cover 110 comprises a flange portion 124 adapted to rotatably engage with the first leg member 160 (see FIG. 6). The motor cover 110 further comprises a front channel portion 126 having a vertical channel 128, a vertical channel 130, and a horizontal channel 132. As will be described more fully herein, the front channel portion 126 is adapted to receive and slidably engage with the first vent member 180. The motor cover 110 further comprises a rear channel portion 134 having a vertical channel 136, a vertical channel 138, and a horizontal channel 140. The rear channel portion 134 is adapted to receive and slidably engage with the second vent member 204. As previously described, the air blower unit 26 comprises a protective cover 142 formed as part of the motor cover 110, and comprising an elongated open channel portion 144 having an inner end portion 146, an outer end portion 148, and side walls 150 and 152. As previously described and shown in FIGS. 16 and 17, the sidewalls 150 and 52 are adapted to engage within the abutting side wall channels 84 and 86 of the open channel portion 82 of the motor housing 62 to enclose and protect the electrical cord 32 passing in the open channel portion 82. The outer end portion 148 of the protective cover 142 is adapted to pass thru the opening 100 of the second exhaust portion 72 so that electrical cord 32 can pass from within the motor cover 110 into the exhaust port 28.

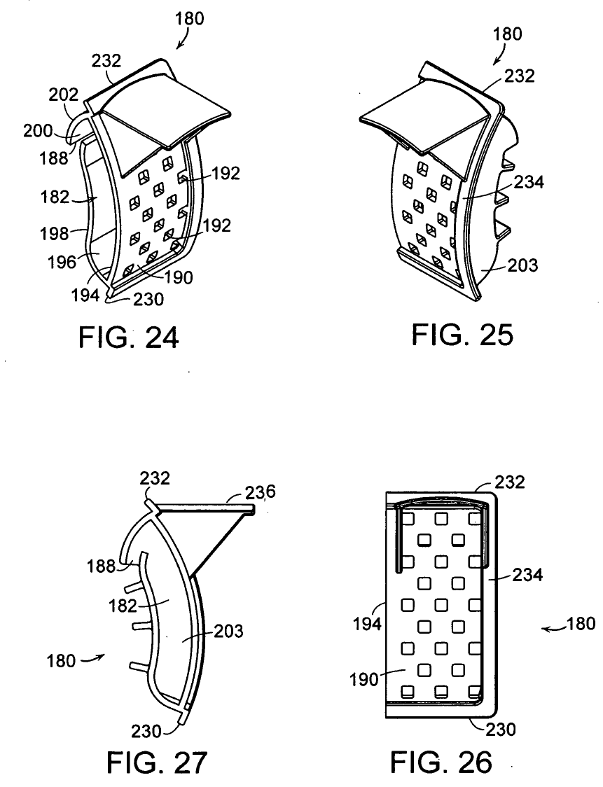

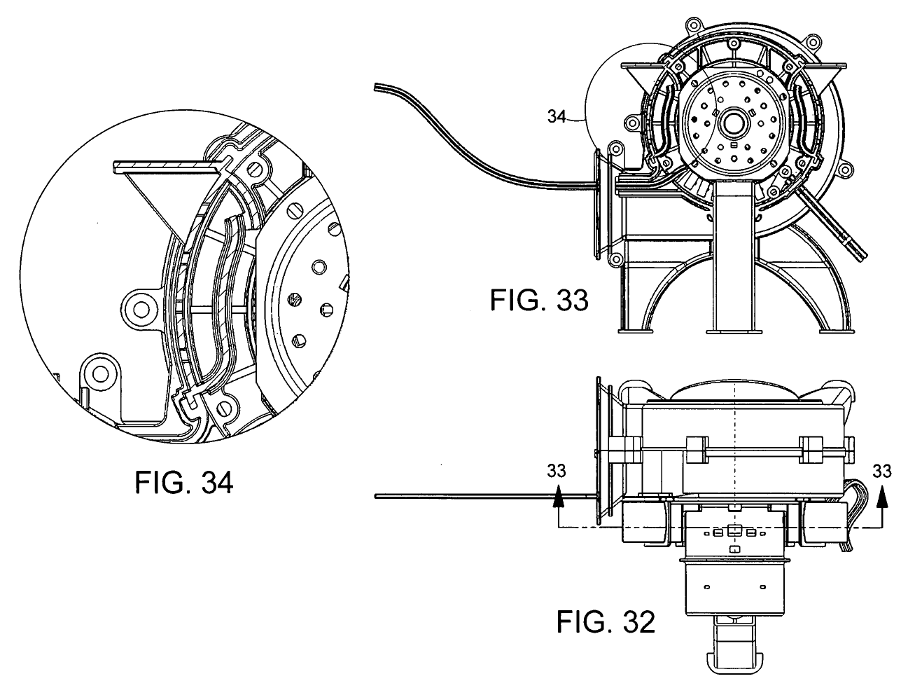

Referring to FIGS. 24-27, and FIGS. 32-34, the first vent member 180 generally comprises an open cavity portion 182 and an air passage way 188 formed by a side wall 203, an exterior wall 190, and interior walls 196 and 200. The exterior wall 190 comprises a plurality of exterior vent holes 192 to allow air to pass into and/or out of the air passage way 188 and the motor cavity 156. The exterior wall 190 has a bottom edge portion 194 that engages within the exterior channel portion 88 of the motor housing 62 (FIG. 14). The interior wall 196 has a bottom edge portion 198 that engages within the interior channel portion 90 of the motor housing 62 (FIG. 14). The interior wall 200 has a bottom edge portion 202 that engages within the interior channel portion 92 of the motor housing 62 (FIG. 14). The first vent member 180 further comprises side edges 230 and 232 and a top edge 234. Side edges 230 and 232 and top edge 234 are adapted to slidably engage with front channel portion 126 of the motor cover 110 (FIG. 18). Specifically, the side edges 230 and 232 are adapted to slidably engage with vertical channels 128 and 130, respectively, while top edge 234 is adapted to slidably engage within horizontal channel 132 to secure the first vent member 180 to the motor cover 110. The first vent member 180 may further comprise a water shield 236 disposed above the vent holes 192 at the upper end of the first vent member 180.

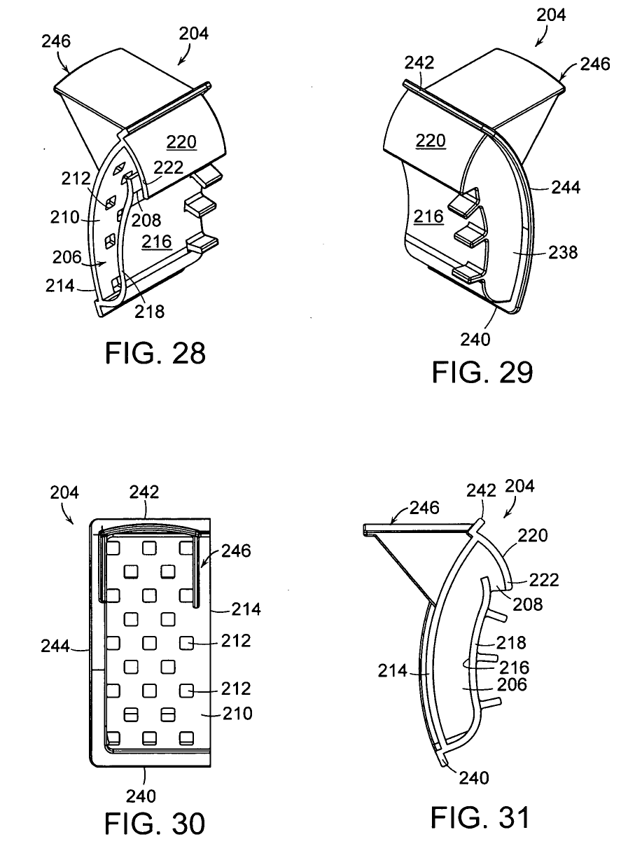

Referring to FIGS. 28-31, the second vent member 204 is a mirror image of the first vent member 180. The second vent member 204 generally comprises an open cavity portion 206 and an air passage way 208 formed by a sidewall 238, an exterior wall 210 and interior walls 216 and 220. The exterior wall 210 comprises a plurality of exterior vent holes 212 to allow air to pass into and/or out of the air passage way 208 and the motor cavity 156. The exterior wall 210 has a bottom edge portion 214 that engages within the channel portion 94 of the motor housing 62 (FIG. 14). The first interior wall 216 has a bottom edge portion 218 that engages within the interior channel portion 96 of the motor housing 62. The second interior wall 220 has a bottom edge portion 202 that engages within the interior channel portion 98 of the motor housing 62. Side edges 240 and 242 and a top edge 244 are adapted to slidably engage with rear channel portion 134 of the motor cover 110 (FIG. 18). Specifically, the side edges 240 and 242 are adapted to slidably engage with vertical channels 136 and 138, respectively, while top edge 244 is adapted to slidably engage within horizontal channel 140 to secure the second vent member 204 to the motor cover 110. The second vent member 204 may further comprise a water shield 246 disposed above the vent holes 212 at the upper end of the second vent member 204.

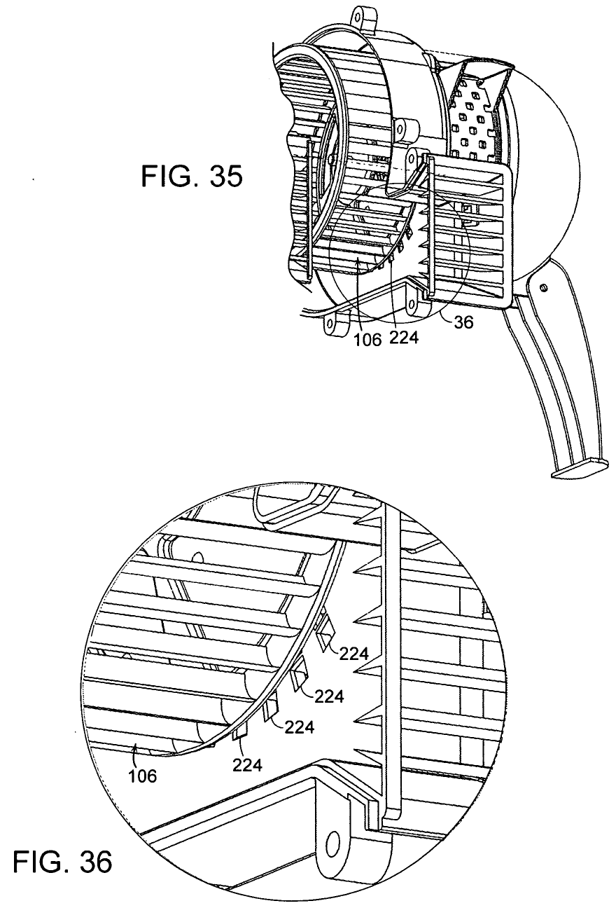

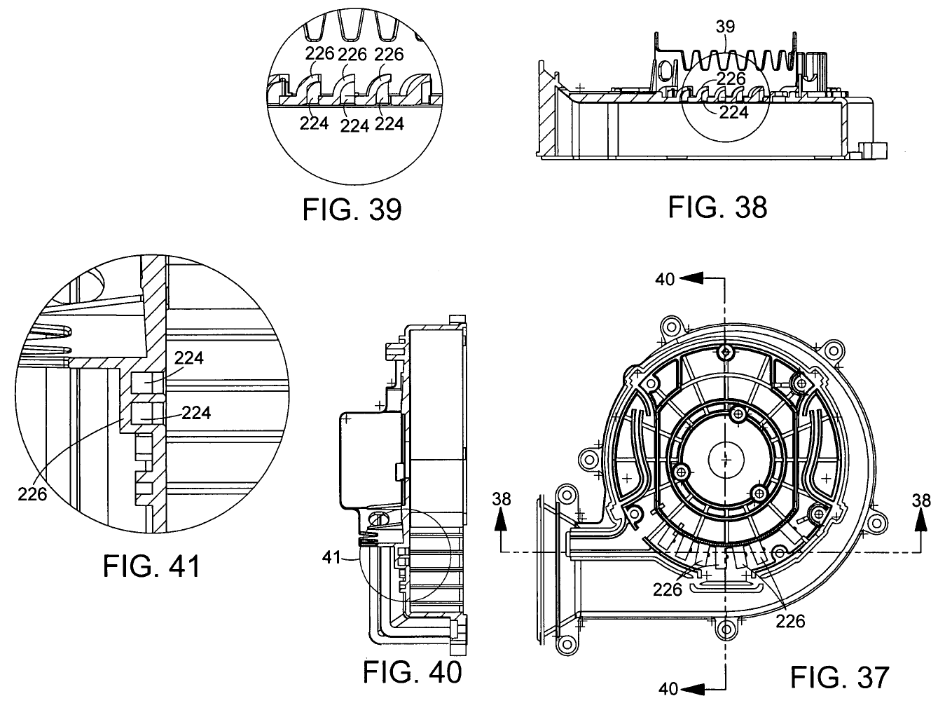

Referring to FIGS. 35 and 36, the air blower unit 26 may further comprise a plurality of interior vent holes 224 formed in the floor portion 64 of the motor housing 62 (FIG. 13) to allow a portion of the air flow generated by the impeller to flow into the motor cavity 156 to cool the motor 102. As best shown in FIGS. 37-41, each of the interior vent holes 224 has a radially shaped water shield 226 extending outward from the floor portion 64. The interior vent holes 224 are disposed in a radial pattern about the floor portion 64 approximate the perimeter of the impeller 106. Upon operation of the air blower unit 26, air is drawn into the air inlet port 50 and a substantial portion is expelled from the exhaust port 28 thru the air inlet sleeve 16 of the body 14. A small portion of the air flow is directed over the motor 102 and out the first and second vent members 180 and 204 to provide cooling and venting of the motor 102.

The inflatable body 14 may take a wide variety of shapes and sizes and is made from an air pervious material such that, when the body is fully inflated, the air being continuously supplied to the body 14 will be offset by the air escaping to the outside through the material. In the embodiment shown, the body 14 is made from 170T Polyester or 190 Denier Nylon and may be fabricated by well known die-cutting, sonic welding and/or sewing operations. The air blower unit 26 may be made with conventional materials and fabricated by conventional processes. For example, the impeller housing 44, motor housing 62, motor cover 110, and vent members 180 and 204 may be made from plastic materials and fabricated by well known molding processes.

The foregoing description is intended primarily for purposes of illustration. This invention may be embodied in other forms or carried out in other ways without departing from the spirit or scope of the invention.

What is claimed:

1. An air blower unit for inflating an air permeable body having an inlet sleeve extending therefrom, the inlet sleeve having a distal end, and the body having a light unit located within, the air blower unit comprising: an exhaust port engageable with the distal end of the inlet sleeve for delivering air to the body thru the inlet sleeve; and an electrical cord passing from the air blower unit through the inlet sleeve of the body and engageable with the light unit.

2. The air blower unit of claim 1, wherein said electrical cord passes out of said exhaust port and through said inlet sleeve of said body.

3. The air blower unit of claim 2, further comprising a protective cover adapted to enclose said electrical cord passing into said exhaust port.

4. The air blower unit of claim 3, wherein said protective cover comprises an end portion extending into said exhaust port.

5. The air blower unit of claim 4, further comprising a motor cover engaged with a motor housing; said motor cover comprising a lower end portion and an upper end portion; said protective cover extending from said lower end portion of said cover portion within said exhaust port.

6. The air blower unit of claim 5, wherein said protective cover comprises an elongated open channel portion engaged with said motor housing.

7. The air blower unit of claim 6, wherein said motor housing comprises an elongated open channel portion adapted to engage with said elongated open channel portion of said protective cover.

8. The air blower unit of claim 7, wherein said protective cover is formed as part of said motor cover.

9. An air blower unit for inflating an air permeable body having an inlet sleeve with extending therefrom, the inlet sleeve having a distal end, the air blower unit comprising: an exhaust port engageable with the distal end of the inlet sleeve for delivering air to the body thru the inlet sleeve; and a first leg member engaged with said motor cover.

10. The air blower unit of claim 9, wherein said first leg member is engaged with said motor cover and is movable between a stored position and a deployed position

11. The air blower unit of claim 10, further comprising second and third leg members engaged with said motor housing and forming a triangular pattern.

12. The air blower unit of claim 11, further comprising an impeller housing engaged with said motor housing; said second and third legs being fixedly secured to said impeller housing.

13. An air blower unit for inflating an air permeable body having an inlet sleeve extending therefrom, the inlet sleeve having a distal end, the air blower unit comprising: an exhaust port engageable with the distal end of the inlet sleeve for delivering air to the body thru the inlet sleeve; a motor housing having a floor portion; an interior vent hole extending thru said floor portion; a motor engaged with said floor portion; and a motor cover engaged with said motor housing to substantially enclose said motor and said interior vent holes.

14. The air blower unit of claim 13, further comprising a water shield extending from said floor portion over said interior vent hole.

15. The air blower unit of claim 13, comprising a plurality of interior vent holes, and a corresponding plurality of water shields extending said floor portion over said vent holes.

16. The air blower unit of claim 13, further comprising a first vent member engaged with said motor cover and having a plurality of exterior vent holes in fluid communication with said interior vent hole.

17. The air blower unit of claim 16, wherein said first vent member is engaged with said motor housing.

18. The air blower unit of claim 17, wherein said first vent member comprises an open cavity portion and a passage way defined by an exterior wall having a bottom edge portion and first and second interior walls each having a bottom edge bottom portion.

19. The air blower unit of claim 18, wherein said motor housing comprises an exterior channel portion and first and second interior channel portions; said bottom edge portion of said exterior wall of said first vent member is engaged with said exterior channel portion of said motor housing; said bottom edge portions of said first and second interior walls of said first vent member are engaged with said first and second interior channels, respectively, of said motor housing.

20. The air blower unit of claim 25, further comprising a second vent member engaged with said motor cover and having a plurality of exterior vent holes; said second vent member is engaged with said motor housing and said interior vent hole is in fluid communication with said exterior vent holes of said second member.
